(19) United States
(12) Patent Application Publication
(10) Pub. No.: US 2024/0060192 A1
(43) Pub. Date: Feb. 22, 2024

(54) Hydrox as an Industrial Fuel

(71) Applicant: Erthos IP LLC, Tempe, AZ (US)

(72) Inventor: James S Tyler, Tempe, AZ (US)

(73) Assignee: Erthos IP LLC, Tempe, AZ (US)

(21) Appl. No.: 18/178,710

(22) Filed: Mar. 6, 2023

Related U.S. Application Data
(63) Continuation-in-part of application No. 17/820,222, filed on Aug. 16, 2022, now abandoned.
(60) Provisional application No. 63/387,543, filed on Dec. 15, 2022.

(51) Int. Cl. C25B 1/044; C25B 9/70

(52) U.S. Cl. CPC C25B 1/044; C25B 9/70

(57) ABSTRACT

A method comprising generating process heat from hydrox. In some versions, hydrox comprises at least 10%, 50%, 60%, 70%, 90%, or 99% by volume or by weight of a material having a stoichiometric ratio of hydrogen gas and oxygen gas. The process sometimes further comprises a step of providing an electric hydrox generator (EOG) and some EOG comprise an electrolyzer to produce hydrox. Versions of the (hydrox generator) electrolyzer have two or more cells, some of which sometimes exhibit a variable resistance function. Depending upon the version, the variable resistance function is measured or controlled electrically, mechanically, or electro-mechanically. Similarly, in these or other versions the EOG operates using photovoltaic electricity, which sometimes comes from a group of modules (such as 100 or more modules) arranged flatly on the ground. In some versions of the EOG, the power path does not contain a device that functions to adjust the voltage of the electricity in the power path. The disclosed methods can combust hydrox such that the combustion exhaust has less than 1000 NOx ppb. In various versions the hydrox feeds a boiler, furnace, turbine, engine, or other device using fuel.

### RELATED APPLICATION(S)

This application is a continuation-in-part of U.S. patent application Ser. No. 17/820,222, filed 22 Aug. 2022, pending and claims priority to U.S. provisional Pat. App. Ser. No. 63/387,543, filed on 15 Dec. 2022, both of which are incorporated into this document by this reference.

### BACKGROUND ART

Most hydrogen produced today in the United States is made via steam-methane reforming, a mature production process in which high-temperature steam (700° C.-1,000° C.) is used to produce hydrogen from a methane source, such as natural gas. Unfortunately, this hydrogen production process is not a green or carbon-neutral process.

Hydrogen has been used as fuel in hydrogen-oxygen welding processes and has been mixed into hydrocarbon fuels. But if hydrogen is combusted with nitrogen present, NOx is produced. For example, see FIG. 1 in which a mixture of hydrogen (H₂), hydrocarbon fuel, and air are supplied to a boiler to produce steam to power a steam-powered process or device. But the boiler also produces NOx in the combustion gases.

NOx stands for mixtures comprising nitric oxide (NO) gases and nitrogen dioxide (NO₂) gases, which are substantial causes of air pollution. These gases contribute to the formation of smog and acid rain. NOx gases are usually produced from the reaction between nitrogen and oxygen during the combustion of fuels, such as hydrocarbons, in air. These gases can be further oxidized in the atmosphere to nitric acid. In large cities, nitrogen oxides are a significant source of air pollution.

Other than some esoteric bio-hydrogen production, green hydrogen production requires a renewable electricity source such as wind or solar photovoltaic modules.

### Renewable Electricity

Solar photovoltaic electricity is an example of a renewable electricity source. Solar modules are assemblies of multiple photovoltaic (PV) cells wired to form a single unit, typically rigid but sometimes flexible. Typically the modules are framed, but frameless panels can also be used. Multiple solar modules can be wired together in series to form an array of strings. These strings connect to a power-receiving unit that provides power, typically an inverter or other controller, that provides power. One or more solar arrays compose a solar plant.

Most renewable electricity is from intermittent sources such as photovoltaics or wind. Another way of saying “intermittent” is to say that renewable electrical sources produce variable DC output, which is problematic for utility-scale energy production.

Utility-scale solar PV power plants differ from other solar power and electricity installations. Due to the size, energy cost, safety regulations, and operating requirements of utility-scale power plants, the components, hardware design, construction means and methods, operations, and maintenance all have specific, unique features earning the designation utility-scale.

FIG. 2 shows a pictogram of a prior art system 10 that provides power for an electrolyzer 27 by converting DC power to AC power, transmitting power through grid 24, and converting back to DC to power. This process is method 301, shown in flow chart form in FIG. 3.

In system 10, variable DC power generated by one or more DC generators 20 is converted using DC/AC inverter 21. DC/AC inverter 21 contains a maximum power point tracker, which adjusts the load on the generators to maximize the power delivered to inverter 21. Inverter 21 converts the power into AC power, which feeds step-up transformer 22 and is transmitted along or over grid 24. Some versions have a shorter intermediate voltage connection 23 and a second step-up transformer (not shown). Grid power usually has a substantially constant current and voltage. At the electrolyzer site, step-down transformer 25 and rectifier 26 convert the AC power into DC power suitable for electrolyzer 27 and transfer it to electrolyzer 27. electrolyzer 27 converts water into a mixture of hydrogen and oxygen or structures in electrolyzer 27 separate the hydrogen and oxygen as they form. Then, the mixture of hydrogen and oxygen or separate streams of hydrogen and oxygen go through further gas separation in gas separator 28. At that point, hydrogen and oxygen are stored separately in tank 11.

Returning to FIG. 3, method 301 comprises the steps set out below. Step 320 produces DC electricity. This is followed by step 330, which converts DC electricity into AC electricity with inverter 21. This energy is fed into step-up transformer 22 to transform the electricity to high-voltage AC in step 340. The high-voltage electricity is transmitted across grid 24 to the location of electrolyzer 27 in step 350. At that location, in step 360, electricity from grid 24 is fed to step-down transformer 25 to transform it into a voltage suitable for electrolyzer 27. In step 370, the reduced voltage AC is rectified into DC power with rectifier 26. Electrolyzer 27 uses the electricity from step 370 to electrolyze water in step 380. Hydrogen and oxygen are the products from electrolyzer 27, and at least the hydrogen is collected in step 390. Optional step 300 separates the hydrogen and oxygen generated in step 390 using gas compressor 29. And optional step 310 stores the hydrogen and oxygen in tank 11.

FIG. 4 shows a similar system, except that DC generator 26 has been replaced by PV array 40.

Prior art solutions to the DC variability described above include using maximum power point trackers that convert the variable DC voltage into a voltage matched to the DC load (inverter) such that the power output is maximized or matched to the load. This arrangement leads to typical electrolyzer operation when using a renewable source. The process flows like this:
a renewable system generates variable DC power;
the variable DC power feeds an expensive, capital-equipment maximum power point tracker, which creates constant DC power;
the constant DC power feeds an expensive, capital-equipment inverter, which creates AC power;
the AC power feeds the AC grid;
the AC grid distributes AC power to the electrolyzer site at a grid voltage;
an expensive, capital-equipment transformer converts AC grid voltage to an AC voltage suitable for the electrolyzer;
an expensive, capital-equipment rectifier converts the AC voltage into a DC voltage and
the DC voltage feeds the electrolyzer.
   Some prior electrolysis methods co-locate the variable DC power generation with the electrolyzer.

### SUMMARY

A method comprising generating process heat from hydrox is disclosed. In some of these versions, hydrox comprises at least 10%, 50%, 60%, 70%, 90%, or 99% by volume or by weight of a material having a stoichiometric ratio of hydrogen gas and oxygen gas. In some embodiments, hydrox is a gas comprising a molar ratio of from 1:1 hydrogen gas to oxygen gas to 4:1 hydrogen gas to oxygen gas, 1.2:1 hydrogen gas to oxygen gas to 3.75:1 hydrogen gas to oxygen gas, 1.4:1 hydrogen gas to oxygen gas to 3.5:1 hydrogen gas to oxygen gas, 1.6:1 hydrogen gas to oxygen gas to 3:1 hydrogen gas to oxygen gas, 1.8:1 hydrogen gas to oxygen gas to 2.5:1 hydrogen gas to oxygen gas, or 1.9:1 hydrogen gas to oxygen gas to 2.1:1 hydrogen gas to oxygen gas.

The process sometimes further comprises a step of providing an electric hydrox generator (EOG) and some EOG comprise an electrolyzer to produce hydrox.

Versions of the electrolyzer have two or more cells, some of which sometimes exhibit a variable resistance function. Depending upon the version, the variable resistance function is measured or controlled electrically, mechanically, or electro-mechanically.

Similarly, in these or other versions the EOG operates using photovoltaic electricity, which sometimes comes from a group of modules (such as 100 or more modules) arranged flatly on the ground.

In some versions of the EOG, the power path does not contain a device that functions to adjust the voltage of the electricity in the power path.

The disclosed methods can combust hydrox such that the combustion exhaust has less than 1000 NOx ppb.

In various versions the hydrox feeds a boiler, furnace, turbine, engine, or other device using fuel.

### BRIEF DESCRIPTION OF THE DRAWINGS

FIG. 1 diagram showing prior art method of burning hydrogen.

FIG. 2 is a diagram showing prior art methods of generating hydrogen.

FIG. 3 is a flowchart showing prior art methods.

FIG. 4 is a diagram showing the components of a prior art process.

FIG. 5 is a diagram showing the components of a process.

FIG. 6 is a flowchart.

FIG. 7 is a diagram showing a process as disclosed.

FIG. 8 is a flowchart.

FIG. 9 is a flowchart.

FIG. 10 is a diagram showing a process as disclosed.

FIG. 11 is a flowchart.

FIG. 12 diagram showing a disclosed method of burning hydrogen.

FIG. 13 is a schematic perspective view of a module.

FIG. 14 is a schematic perspective view of a module array.

FIG. 15 is a schematic cross-section of a module array including a prior art module mount.

FIG. 16 is a schematic cross-section of a module.

FIG. 17 is a schematic view of an Earth Mount PV system.

FIG. 18 is a cross-section of a string of Modules.

FIG. 19 is an expanded view of 8.

FIG. 20 is a schematic view of an edge block.

FIG. 21 is a perspective view of a cleaning robot.

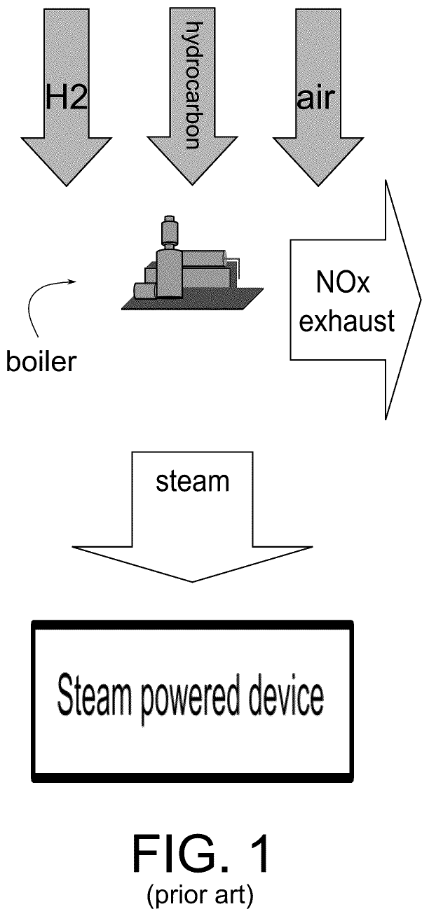

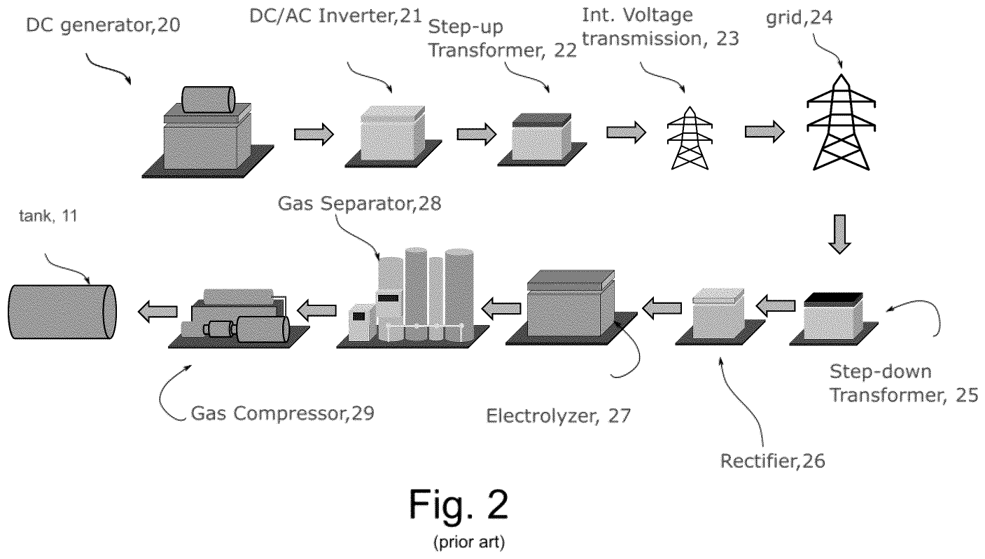

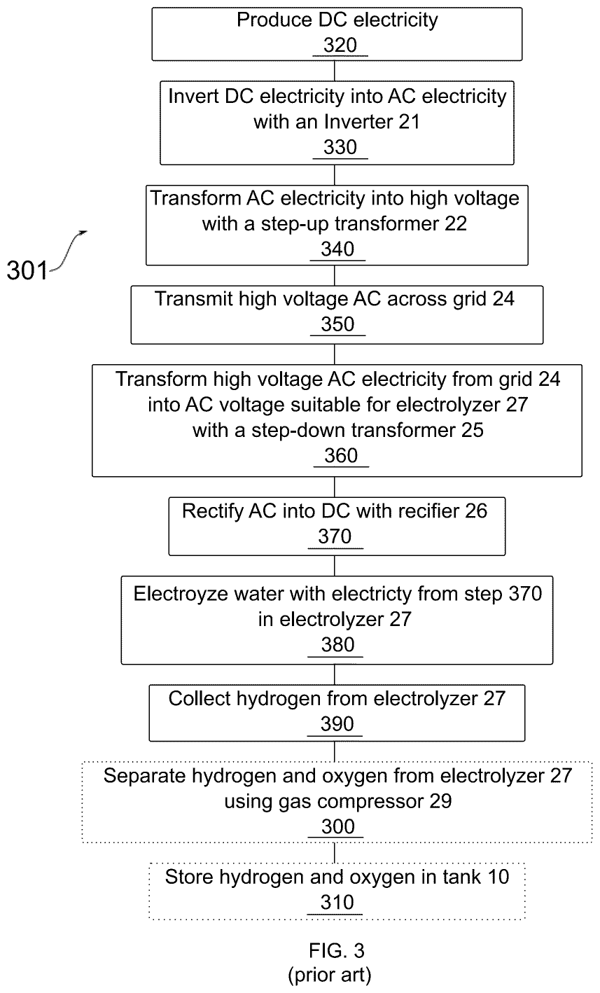

### DETAILED DESCRIPTION

To the extent that the material doesn't conflict with the current disclosure, this disclosure incorporates by reference the entire contents of the following pat. app. Ser. No. 17/153,845; 63/120,931; 63/079,778; 63/021,825; 63/052,369; 63/052,367; 62/963,300; 17/152,663; 63/021,928; 62/903,369; 16/682,503; 16/682,517; 17/079,949; 63/172,599; 17/316,647; 17/316,535; 17/336,393; 17/336,404; 17/336,407; 17/336,417; 17/336,431; 17/336,442; 17/336,699; 17/337,234; and Ser. No. 17/337,240.

Unless defined otherwise, all technical and scientific terms used in this document have the same meanings as commonly understood by one skilled in the art to which the disclosed invention pertains. Singular forms—a, an, and the—include plural referents unless the context indicates otherwise. Thus, reference to “fluid” refers to one or more fluids, such as two or more fluids, three or more fluids, etc. When an aspect is to include a list of components, the list is representative. If the component choice is limited explicitly to the list, the disclosure will say so. Listing components acknowledges that implementations exist for each component and any combination of the components—including combinations that specifically exclude any one or any combination of the listed components. For example, “component A is chosen from A, B, or C” discloses implementations with A, B, C, AB, AC, BC, and ABC. It also discloses (AB but not C), (AC but not B), and (BC but not A) as implementations, for example. Combinations that one of ordinary skill in the art knows to be incompatible with each other or with the components' function in the invention are excluded, in some implementations.

When an element or layer is called being “on”, “engaged to”, “connected to” or “coupled to” another element or layer, it may be directly on, engaged, connected, or coupled to the other element or layer, or intervening elements or layers may be present. When an element is called being “directly on”, “directly engaged to”, “directly connected to”, or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.).

Although the terms first, second, third, etc., may describe various elements, components, regions, layers, or sections, these elements, components, regions, layers, or sections should not be limited by these terms. These terms may distinguish only one element, component, region, layer, or section from another region, layer, or section. In addition, terms such as “first”, “second”, and other numerical terms do not imply a sequence or order unless indicated by the context. Thus, a first element, component, region, layer, or section discussed below could be termed a second element, component, region, layer, or section without departing from this disclosure.

Spatially relative terms, such as “inner”, “outer”, “beneath”, “below”, “lower”, “above”, and “upper,” may be used for ease of description to describe one element or feature's relationship to another element or feature as illustrated in the figures. Spatially relative terms may be intended to encompass different orientations of the device in use or operation besides the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations), and the spatially relative descriptors interpreted.

The description of the implementations has been provided for illustration and description. It is not intended to be exhaustive or to limit the invention. Individual elements or features of a particular implementation are not limited to that implementation but, where applicable, are interchangeable and can be used in a selected implementation, even if not explicitly shown or described. The same may also be varied. Such variations are not a departure from the invention, and all such modifications are included within the invention's scope.

### Components

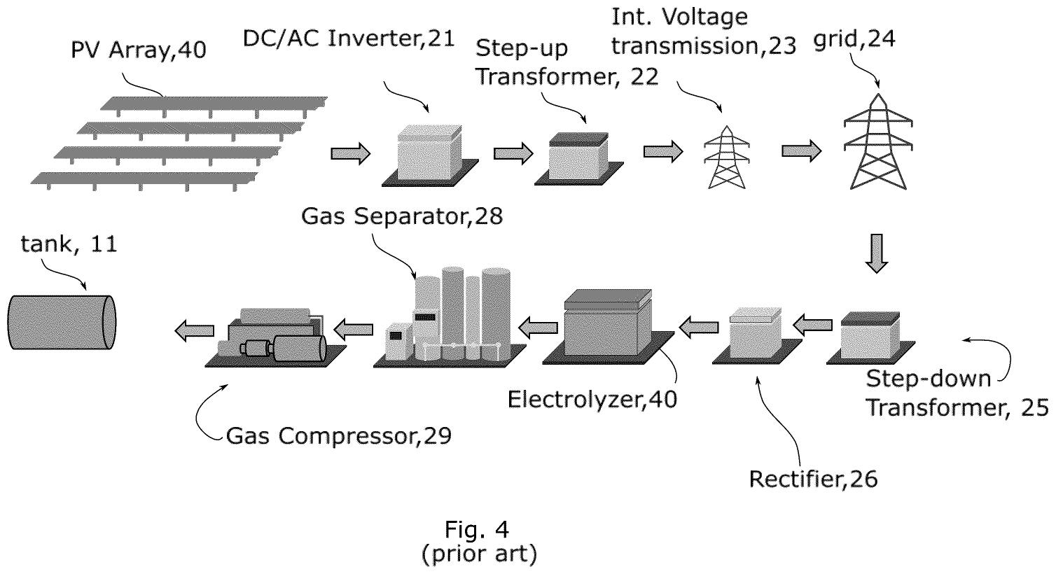

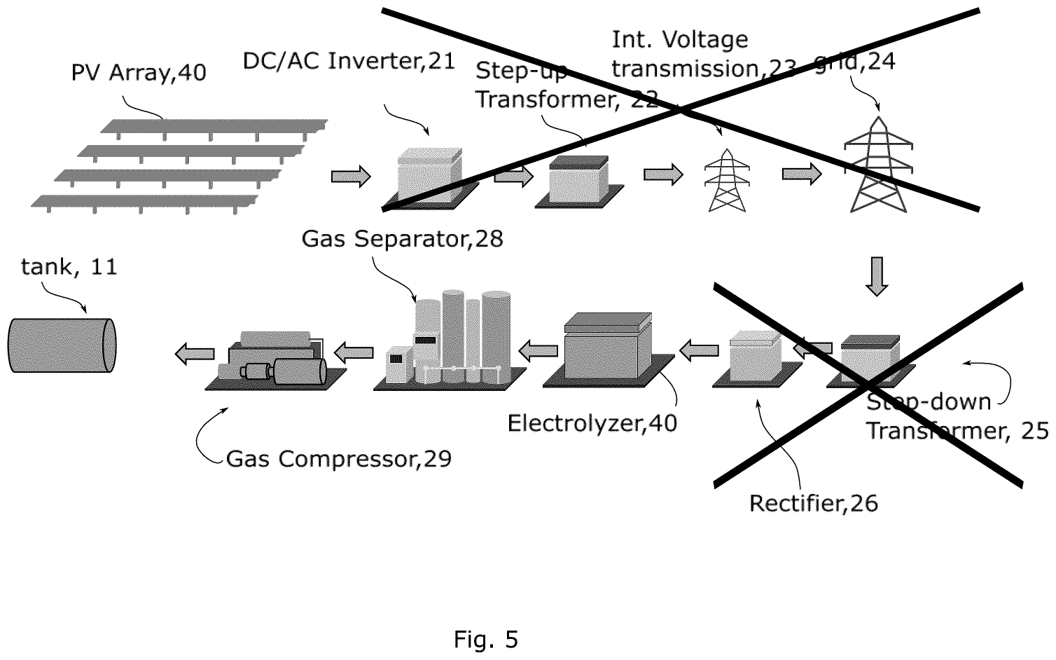

FIG. 5 is a diagram showing an improved process for producing green hydrogen. The figure depicts the same process as disclosed in FIG. 4 but with the components of the prior art that the current process makes extraneous. The current processes disclosed in this document do not use the following components in some embodiments, DC/AC inverter 21, step-up transformer 22, grid 24, intermediate voltage connection 23, optional second step-up transformer (not shown), step-down transformer 25, and rectifier 26. The embodiment depicted in FIG. 5 contains the equipment for separating the hydrogen gas from the oxygen gas, gas separator 28.

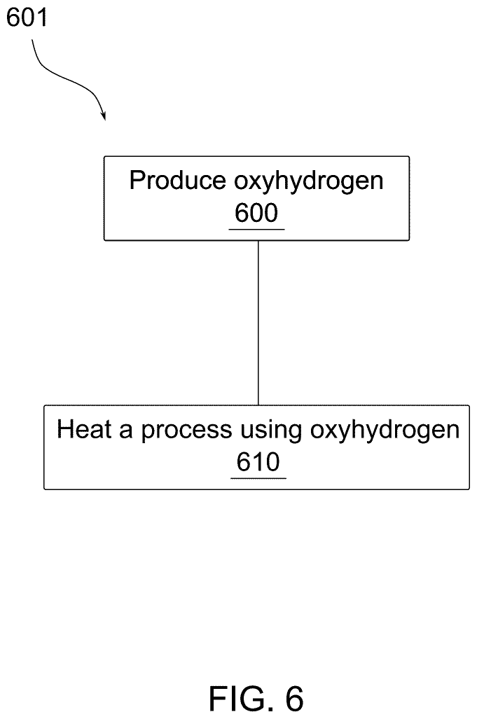

FIG. 6 depicts a flowchart illustrating process 601. Step 600 encompasses producing a mixture of hydrox (oxyhydrogen, HHO) by any known method. This hydrox is used in step 610 for generating heat to heat an industrial process.

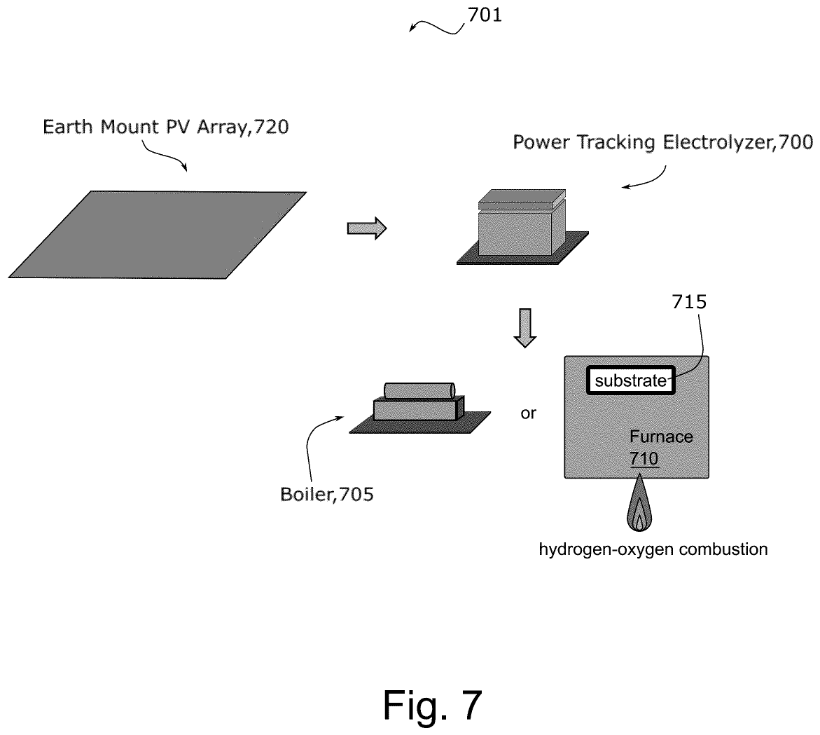

Turning now to a specific method of producing hydrox, FIG. 7 depicts a diagram showing a process 701 operated with Earth Mount PV array 720 feeding DC electricity directly into hydrox generator or power tracking electrolyzer 700. Power tracking electrolyzer 700 has been modified as described below to have the functionality to adjust its power requirements to match the variable DC output of Earth Mount PV array 720. In addition, power tracking electrolyzer 700 produces hydrox, which through connections between electrolyzer 700 and either boiler 705 or a furnace 710, delivers the fuel for combustion to boiler 705 or furnace 710.

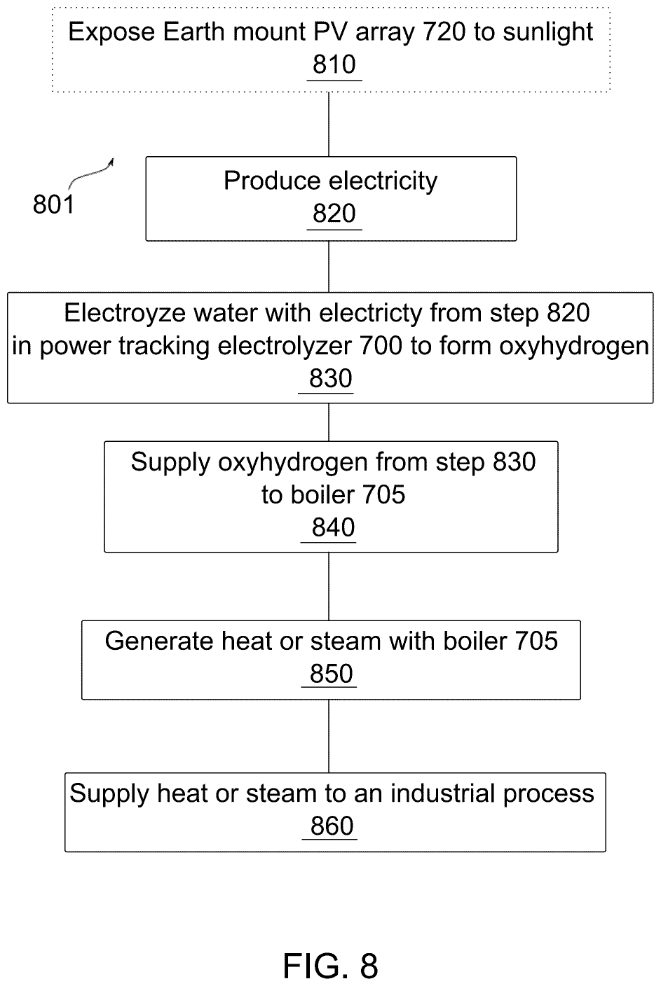

In some embodiments, power tracking electrolyzer 700 generates hydrox that directly passes to a hydrox or hydrogen boiler 705. FIG. 8 illustrates process 801. Step 810 comprises exposing Earth Mount PV array 720 to sunlight. This step produces electricity in step 820. In step 830, the electricity produced in step 820 is supplied to power tracking electrolyzer 700 to form hydrox. Hydrox feeds boiler 705 in step 840, which produces heat or steam in step 850. Finally, the generated heat or steam is supplied to an industrial process in step 860.

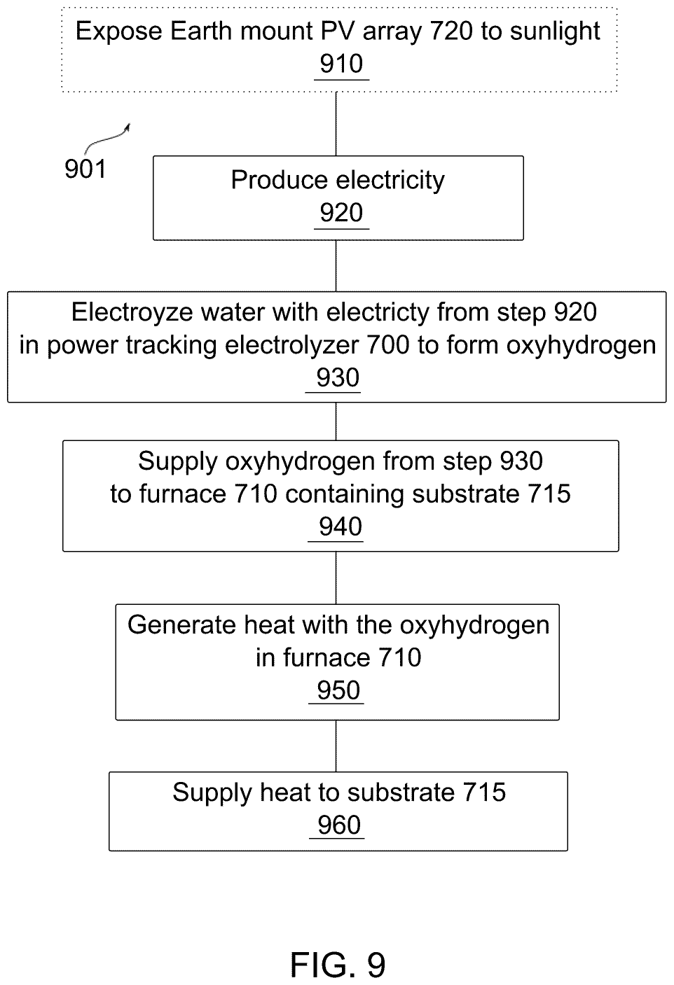

In some embodiments, power tracking electrolyzer 700 generates hydrox that directly passes to a furnace 710. FIG. 9 illustrates process 901, in which PV sunlight is used to provide industrial heating to furnace 710. Step 910 comprises exposing Earth Mount PV array 720 to sunlight. This step produces electricity in step 920. In step 930, the electricity produced in step 920 is supplied to power tracking electrolyzer 700 to form hydrox. Hydrox feeds furnace 710, which contains or can contain substrate 715, in step 940. In step 950, heat is generated in furnace 710 using hydrox as fuel. The heat is supplied to substrate 715 when substrate 715 is within furnace 710 in step 960.

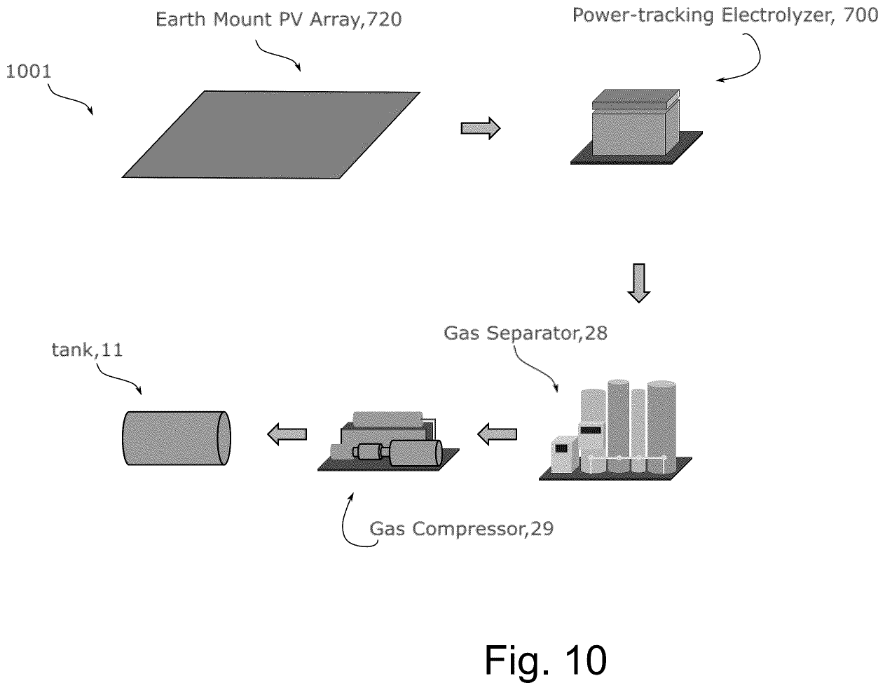

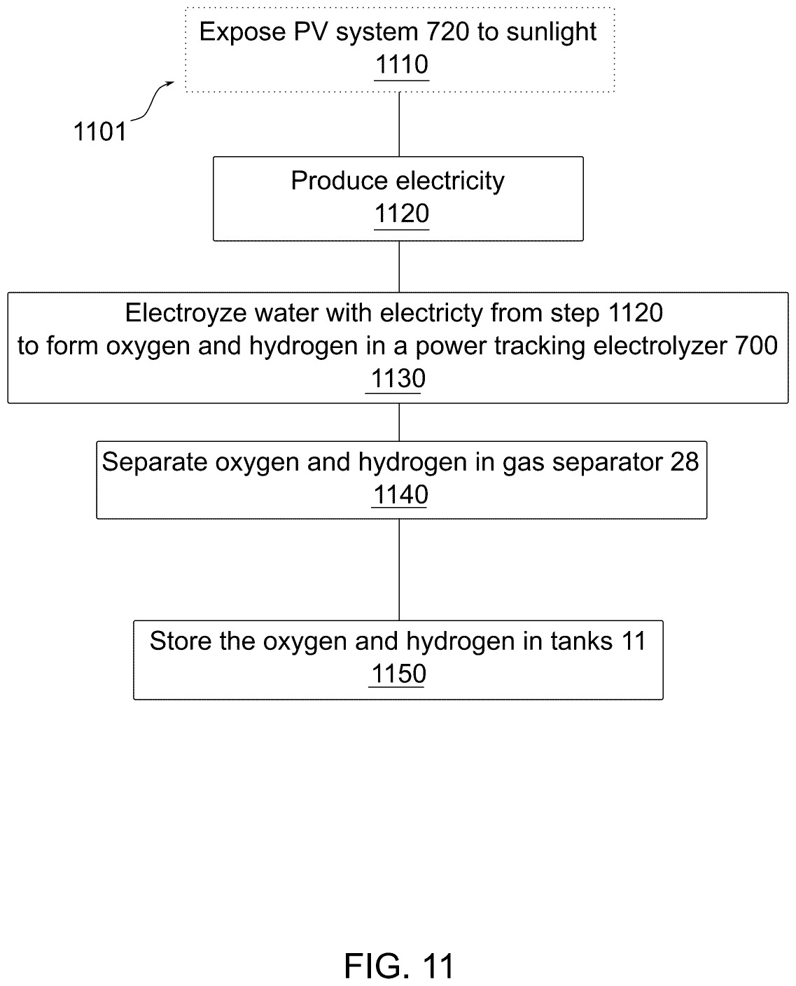

A similar embodiment takes the generated hydrox gas and separates it into oxygen gas and hydrogen gas. A diagram 1001 of this is depicted in FIG. 10. Earth Mount PV array 720 produces electricity, which is supplied to power tracking electrolyzer 700 to form hydrox. Hydrox is separated into hydrogen and oxygen gas either within the power tracking electrolyzer 700 or a prior art electrolyzer or within gas separator 28. Gas compressor 29 compresses the oxygen and hydrogen gas into tank 11 for storage. The flowchart in FIG. 11 illustrates process 1101. Step 1110 comprises exposing Earth Mount PV array 720 to sunlight. This step produces electricity in step 1120. In step 1130, the electricity produced in step 1120 is supplied to power tracking electrolyzer 700 to form hydrox or partially separated oxygen and hydrogen depending on the design of power tracking electrolyzer 700 or of a prior art electrolyzer. In step 1140, the hydrox is separated into oxygen and hydrogen in gas separator 28, or the oxygen and hydrogen are further separated in gas separator 28, as needed. For instance, in embodiments that do not need highly pure hydrogen and oxygen, separation within an electrolyzer is sometimes sufficient without sending the gases through gas separator 28. In step 1150, the oxygen and hydrogen are stored in separate tanks, such as tank 11.

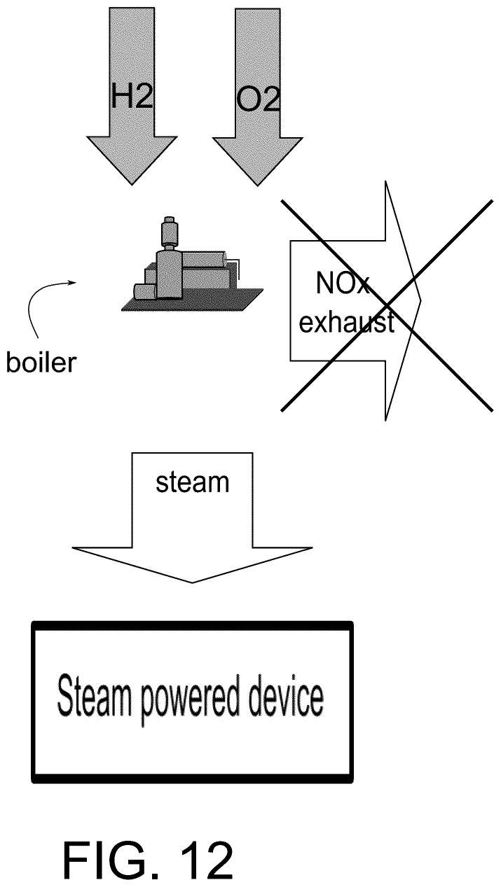

FIG. 12 illustrates the combustion of hydrox or a mixture of previously separated hydrogen and oxygen (depending upon the embodiment) in a boiler. The boiler produces steam, which can power a steam-powered process or device. But when nitrogen is not present, the process does not produce combustion gases containing NOx compared to prior art processes using hydrogen as a fuel and air as the oxidant. The situation is similar when hydrogen and oxygen are fed to a furnace. Again, the disclosed processes of producing heat with hydrogen and oxygen do not produce NOx.

In any embodiment, oxygen gas can be vented to the atmosphere instead of being consumed or stored. Finally, in any of these embodiments, the process would remain functional, albeit less efficient, should the power-tracking electrolyzer be replaced with an electrolyzer that does not track power from the DC source.

Some embodiments of this disclosure do not change DC power from a DC power source into AC power and do not change AC power into DC power. In addition, some embodiments of this disclosure do not use an external maximum power point tracker to match the DC power from the DC power source to the DC power needed by the electrolysis deck. Thus, DC power from a DC power source, such as one or more PV assemblies, is provided directly to an electrolysis stack. Hence, according to this disclosure, systems and methods do not require equipment or components, such as one or more transformers, rectifiers, inverters, or IGBTs. Skipping now-extraneous components reduces equipment expense and maintenance and increases system efficiency.

The variable current and voltage from the DC power generation apparatus are maintained relatively steady (steady-state operation) at the electrolysis stack by adjusting the stack's resistance (which can be measured in ohms). Adjusting the resistance can be done in several ways, such as by, but not limited to, changing or adjusting:
the depth of one or both of the negative or positive electrodes in the electrolytic fluid;
the fluid level (e.g., the fluid height relative to one or more electrodes);
the fluid temperature;
the distance between the positive and negative electrodes;
the number of electrode cells in series;
the number of electrode panels in parallel;
the fluid volume;
the surface area of the electrodes exposed to the electrolyte; and
the stack resistance using some other method.

In one embodiment, the resistance is changed automatically by a controller (or control system) based on changes in the input voltage.

The control system can be an open- or closed-loop control circuit/system to provide the appropriate resistance to match the associated solar energy collected by the DC power source, whereby the maximum power point (MPP) or a desired power point other than the MPP may be achieved. The resultant gas discharge from the stack is proportional to the DC amperage conducted through the stack.

According to this disclosure, a system and method can provide a DC power source, such as one or more PV assemblies, that provides DC power directly to the stack, wherein the DC power has both a variable voltage and variable current. Such variable DC power benefits by using a variable resistance electrolysis stack. Thus, the disclosed systems and methods eliminate the need for one or more energy transformation components, which convert DC power to AC power, change AC voltage, or convert AC power to DC power.

Eliminating these energy transformation components reduces equipment costs by up to over 50%, reduces maintenance costs, and increases the overall system's efficiency by up to or over 20%.

U.S. patent application Ser. No. 17/820,222, filed on 16 Aug. 2022, entitled electrolyzer systems and methods, discusses variable resistance electrolyzers and is incorporated herein by reference

### DC Generators

Wind turbines, as known to ordinarily skilled artisans or variable voltage devices. Standard PV installations or variable voltage devices. Many other variable voltage devices exist, as known to ordinarily skilled letters. Any of these types of devices function in various embodiments disclosed in this document.

### Earth Mount Systems

Variations on utility-scale PV module electricity generating systems are disclosed. These systems are characterized by mounting some or all the modules substantially flat on the ground dispensing with tracker or racking structure (inclusively “racked” systems). Mounting modules flat on the ground results in the module orientation being directed by contact with the ground (earth). Such an orientation is fundamentally different than the custom or semi-custom orientation that racking creates (sun-oriented).

Earth mounting establishes a topographical orientation of the modules, as distinguished from a sun orientation in which the sun's direction dictates the modules' direction.

The modules sit edge-to-edge, end-to-end, or both depending upon the implementation. Earth-mounted systems have a tiny exposure to air (wind) moving across their modules, allowing them to largely dispense with mounting hardware to hold system modules against the ground. But some embodiments use mounting hardware. Various methods of attaching the modules to the ground or each other are contemplated for arrays that use such optional connections. Earth mounting substantially reduces module wind loading, avoiding high wind forces. And Earth-mounted systems have low module elevations.

Also, Earth mounting provides significant advantages when used with commercially available string- or micro-inverters. But Earth mounting does not preclude using industry-standard central inverters or alternate power conversion and transmission technologies.

Earth mounting eliminates the need for the steel structures required by racked systems. Thus, Earth mounting eliminates structural corrosion and increases power plant life expectancy from 25 years to perhaps longer than 40 years while significantly reducing initial costs. Nonetheless, steel, coated or otherwise, can be used with the system. In addition, earth-mounted systems frequently include commercially available and compatible new module cleaning or dust removal techniques.

Earth mounting increases the power density per acre of land, which reduces the needed land area by more than 50% of traditional utility-scale solar plant PV power plants in some cases. In addition, earth mounting allows the PV array to follow the land's existing contour, obviating the need for land preparation such as mass grading, plowing, tilling, cutting, and filling.

Earth mounting reduces wind loading and uplift forces, eliminates module-to-module shading, requires zero or minimal row spacing, and increases the ground coverage ratio. And it orients the modules parallel to existing topography, independent of a site's azimuth angle.

Modules are typically flat rectangles (or any other convenient space-filling shape). Various implementations modify module installation techniques to allow installation directly on the ground and are configured to take advantage of the ground's cooling and heat-sinking effects. Placing the modules sometimes includes using attachment brackets. In some implementations, the modules snap into or otherwise secure the attachment brackets, retaining the array on or near the ground. Ground placement avoids mounting the modules on racks and avoids shadows. No shadows mean no need for substantial spacing between modules.

Earth-mounted systems can be constructed with little or no gaps between adjacent modules. Eliminating the gaps allows a two-dimensional array, when desired, of closely adjacent modules to extend row-wise and column-wise (from row to row). In other words, gaps between sequential modules from row to row can closely approximate gaps between sequential modules along the rows. Ultimately, modules in an Earth-mounted arrangement use far less land area than racked systems. In some implementations, Earth-mounted arrays use less than 50%, 45%, 40%, 35%, or 30% of the land area used by racked systems. Some implementations dispense with module-to-module mechanical connections. Some inter-module connections do not control the spacing between modules.

U.S. patent application Ser. No. 17/746,782, filed on 17 May 2022, entitled Photovoltaic Module Fastening Systems, discusses Earth Mount systems and is incorporated herein by reference.

U.S. patent application Ser. No. 17/836,868, filed on 9 Jun. 2022, entitled Flat Tile Solar Panels-Module Number, discusses Earth Mount systems and is incorporated herein by reference.

U.S. patent application Ser. No. 17/836,918, filed on 9 Jun. 2022, entitled Photovoltaic Modules and Fastening System Plant Module Number, discusses Earth Mount systems and is incorporated herein by reference.

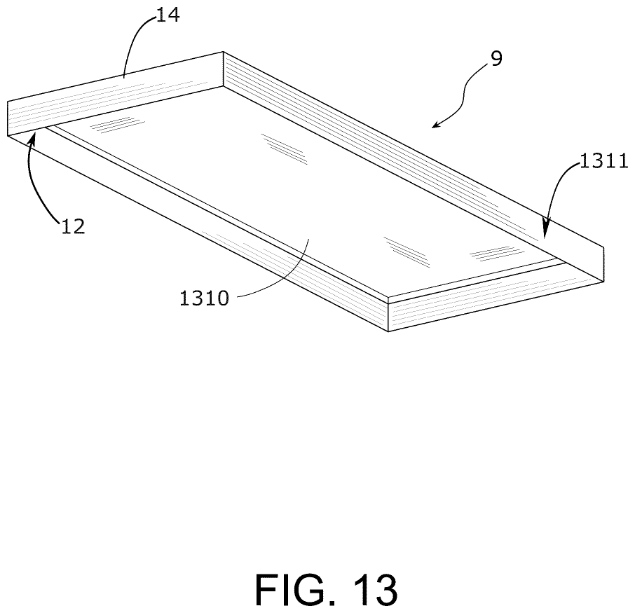

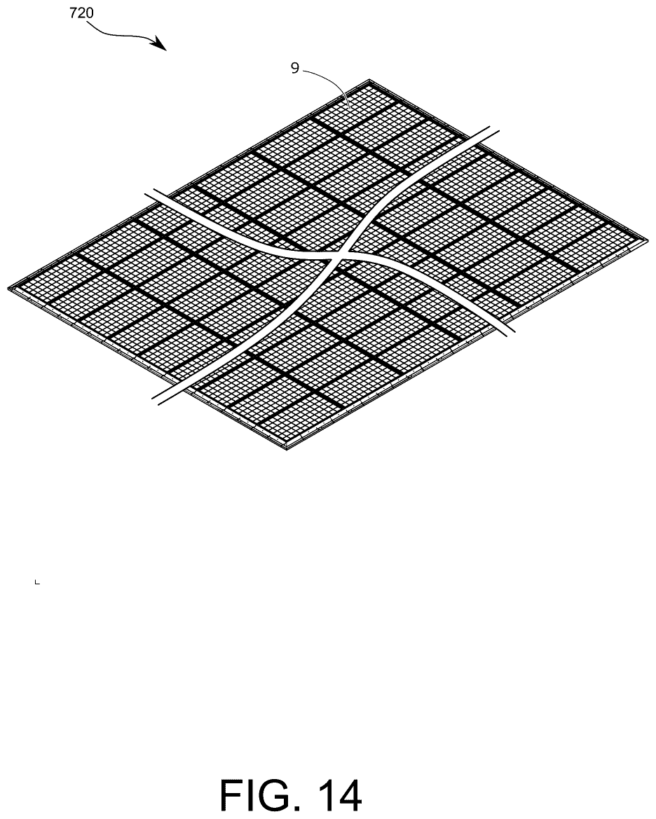

In part, FIG. 13 illustrates a schematic view of module 9 having photovoltaic substrate 1310, frames 1311, edges 12, and module top face 14. Sometimes module 9 is frameless and does not have frames 1311. FIG. 14 is a schematic view comprising modules 9 assembled into Earth Mount PV array 720 mounted flat on the ground 215 following the topography. Some or all modules 9 are mounted to contact the ground 215. Depending upon the version, not all edges 12 touch the ground 215.

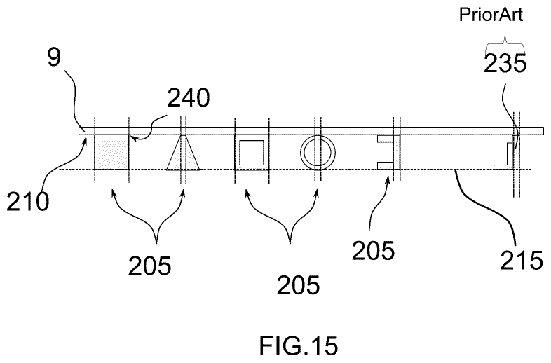

FIG. 15 shows some versions of Earth-mounted systems with structures 205 between modules 9 and ground (grade 215) but not tracker objects or angled racking objects. The figure illustrates a cross-section view of module 9, which has a structure 205 between module bottom 210 and grade 215. Structures 205 meet the definition of “structure” because they are either solid below the contact surface 240 or the volume beneath the contact surface 240 “constrains air movement”. Prior art structure 235 is also shown. As defined below, the inconsequential (in one way or another) objects are called structures. Some Earth-mounted arrays resist wind loads of up to 194 mph without using prior art anchoring or mounting methodologies.

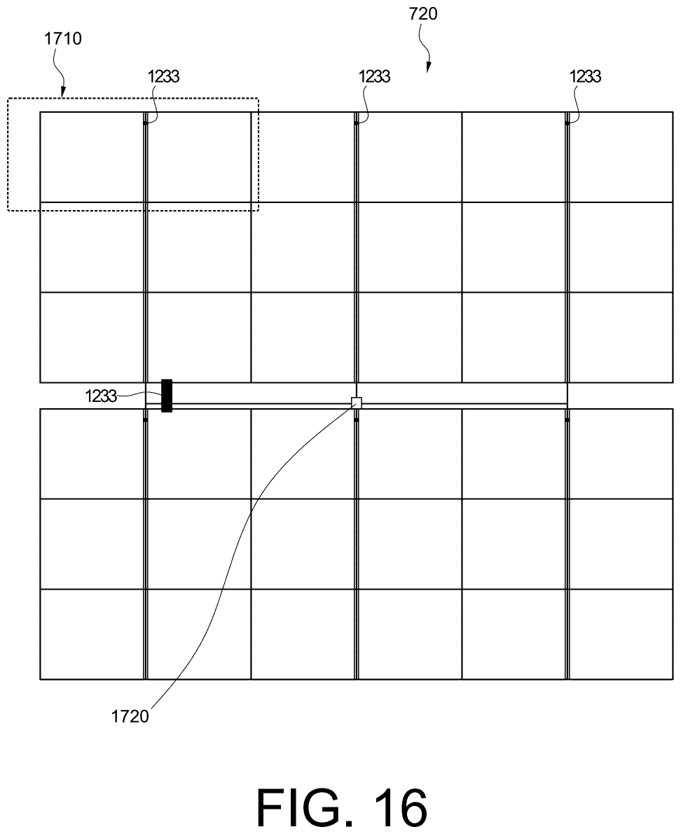

FIG. 16 is a schematic diagram showing an Earth Mount PV array 720 layout for a commercial solar power plant. FIG. 16 shows eighteen of block 1710 in an implementation of a utility-scale plant. Some utility-scale solar power plant implementations have one or more of these arrangements. Optional DC-AC inverter 1720 and robot bridges 1233 are shown, as well.

In some versions, Earth-mounted systems disclosed in this document are mounted at a height, h, of less than 100, 75, 50, or 20 cm above grade on objects that extend into the ground less than one-half of the height.

### Mesh Cable

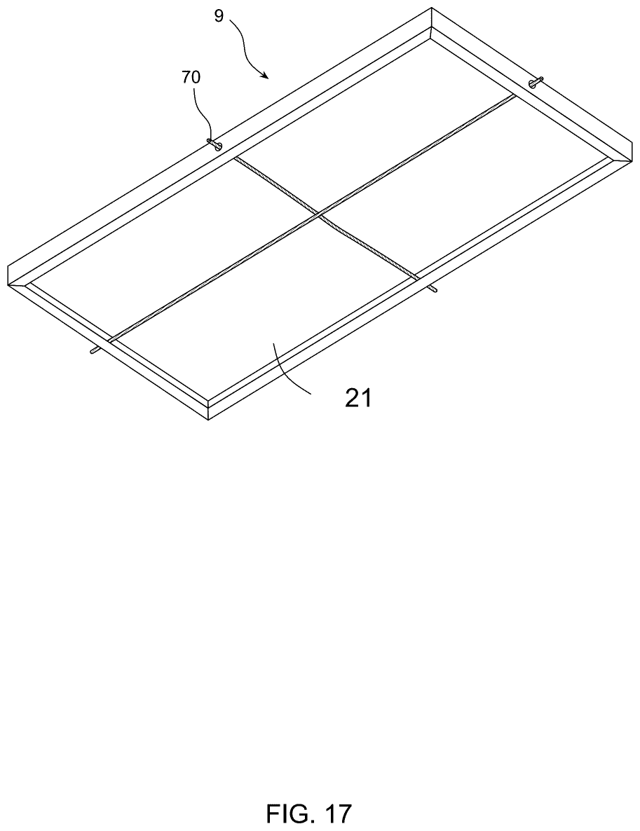

FIG. 17 is a perspective diagram that shows a perspective view of module 9. Mesh cable 70 is shown in the figure and extends along module 9. FIG. 17 also shows the underside of PV substrate 21.

Mesh cable devices work to align adjacent modules in a PV array. FIG. 17 is a perspective view of the underside of module 9 showing a mesh cable device. U.S. patent application Ser. No. 17/316,535, filed on 10 May 2021, entitled Photovoltaic Module Fastening Systems, discusses mesh cable devices and is incorporated herein by reference.

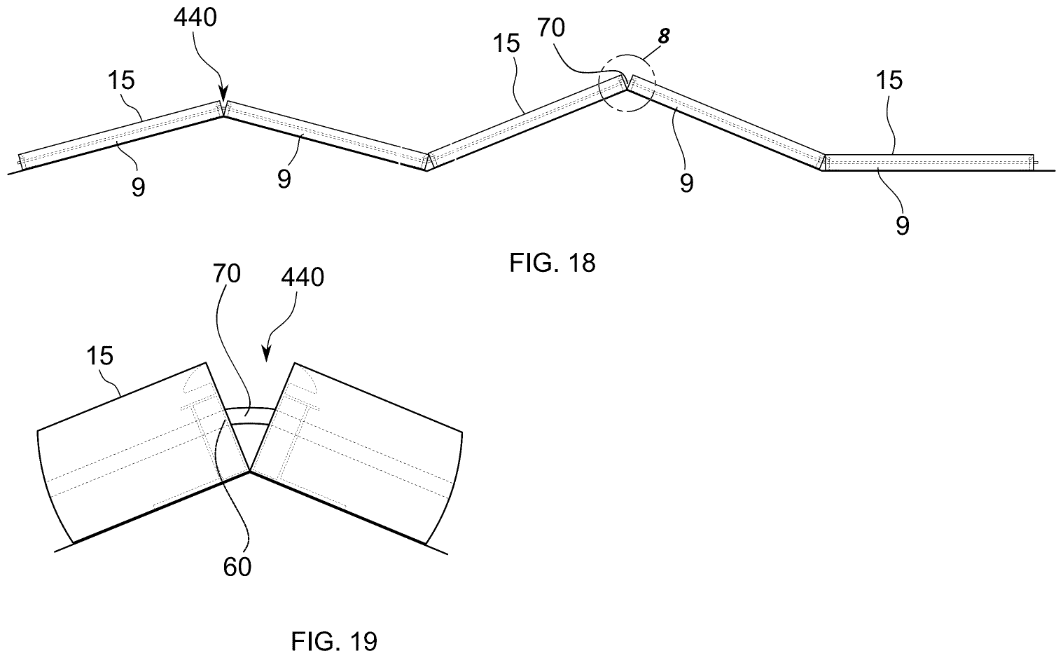

FIG. 18 is a side view of several modules from a row of modules. It shows mesh cable 70 interacting with module 9 through a hole or penetration 60 (see FIG. 19) in module 9.

FIG. 19 shows a magnified view of FIG. 18 having upper gap 440. FIG. 18 depicts modules 9 sitting on a non-flat, earth or ground surface and illustrates the ability of mesh cables 70 to accommodate adjacent modules 9 sitting at different angles. As shown, despite adjacent panels sitting at different angles, mesh cable 70 retains the top edge 15 of each panel or the top surface of each panel at substantially the same height or position. In some exemplars, mesh cables 70 maintain the height of modules 9 close enough to each other to allow an autonomous robotic cleaning system to operate on the array. In some exemplars, mesh cables 70 maintain the height of adjacent modules within 0.25, 0.5, 1, 2, or 3 inches of each other.

### Edge Blocks

US Pat. App. Ser. No. 11,456,695, issued 27 Sep. 2022, relates to edge blocks and is incorporated herein by reference.

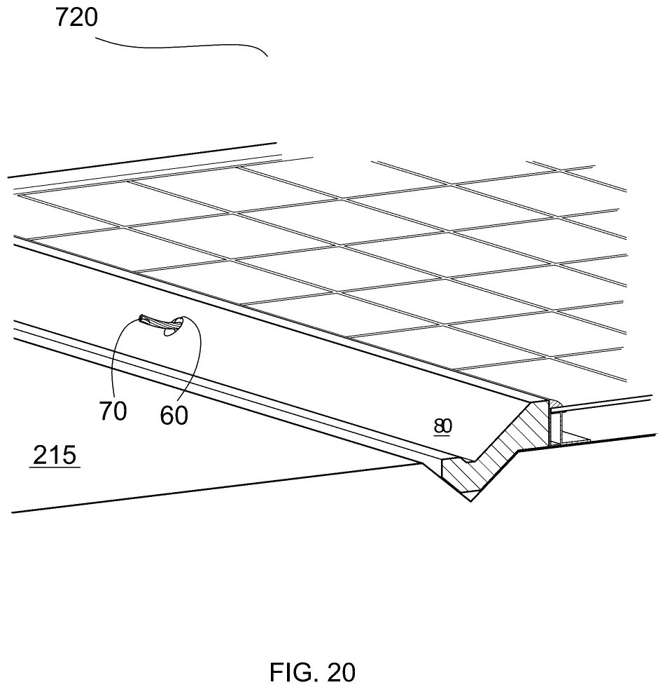

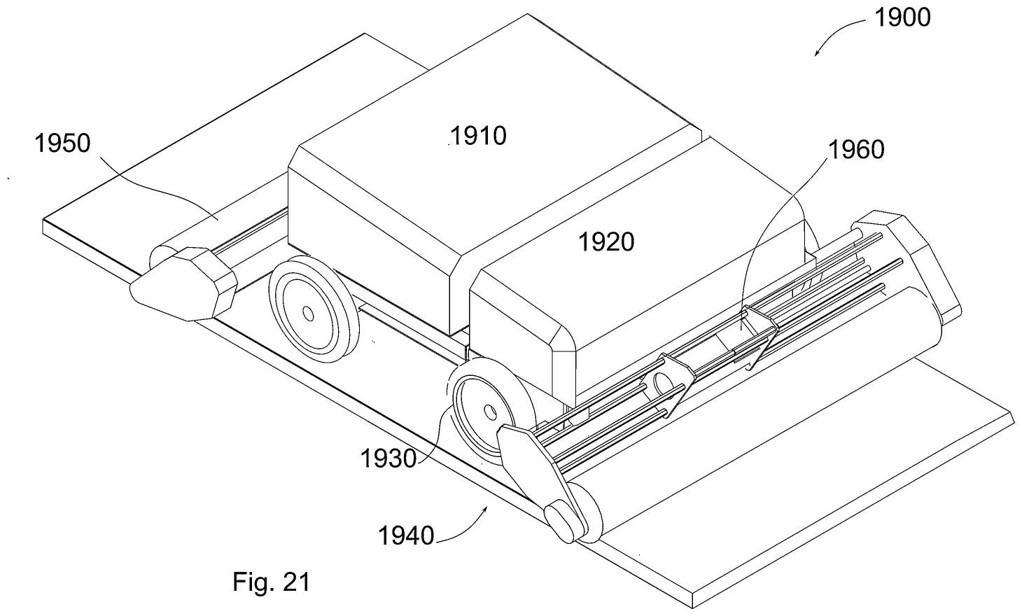

FIG. 20 shows a view of an edge block 80. These devices direct water and wind up and over the flat panels in an Earth Mount PV array 720.

U.S. patent application Ser. No. 17/153,845, filed on 20 Jan. 2021, entitled Photovoltaic Module Fastening Systems, discusses Earth Mount systems and is incorporated herein by reference.

In some versions, the Earth-mounted system mounts the solar panels directly to the earth without an intermediate structure between the modules and the earth itself.

### Robot

Earth Mount systems facilitate more economical module cleaning. Robotic cleaning systems for operation on Earth Mount systems are much simpler than robotics systems for cleaning racked systems. Since Earth-mounted systems are substantially flat, cleaning Earth-mounted systems with autonomous robotics systems is far more economical than cleaning racked systems.

To facilitate robotic cleaning, Earth Mount implementations used connectors to minimize module-to-module z-axis variability. Another way to facilitate robotic cleaning is to provide bridges between separate module sections or separate module arrays. These bridges allow the robot to cross from one section or array to another.

FIG. 21 depicts an autonomous cleaning robot 1900. Autonomous cleaning robot 1900 comprises rear cover 1910, front cover 1920, and wheels 1930. Depending upon the implementation, robot 1900 uses two or more, three or more, for more, six or more, or eight or more wheels 1930. This implementation shows the robot with two brush assemblies 1940, but the cleaning nature of robot 1900 can use one brush assembly 1940. Brush assembly 1940 comprises brush 1950, brush motor 1960, and various other components that connect brush assembly 1940 to robot 1900. Brush assembly 1940 connects to the chassis of robot 1900, and, in some implementations, the chassis of robot 1900 has two pieces. Brush motor 1960 drives the rotation of brush 1950 through a transmission. U.S. patent application Ser. No. 17/478,877, filed 17 Sep. 2021, entitled Autonomous PV Module Array Cleaning Robot, discusses robotic cleaning devices and is incorporated herein by reference.

### Definitions (for Purposes of this Disclosure)

Generally, an industrial process is any process that uses heat at a rate equivalent to greater than 2000, 5000, 10,000, 15,000, 20,000, 40,000, 80,000, 160,000, or 320,000 pounds of steam per hour, depending on the embodiment. Industrial heat refers to many methods by which heat is used to transform materials into valuable products. For example, heat is used to remove moisture, separate chemicals, create steam, treat metals, melt plastics, Agricultural space and media heating, cooking, pressurization, sterilization, and bleaching, industrial distillation, concentrating, drying, or kilning, and chemical or other high-temperature processes, silicon and other refining, including semiconductor production, and much more. Depending upon the process involved, industrial heat can be broken down into low-, medium-, and high-temperature heat. For instance, cement kilns require high temperatures, while drying or washing applications in the food industry operate at lower temperatures. Various practical processes and devices include but are not limited to drying, primary steam reforming, steam, steeping, drying, combustion gases, heating kilns, calciners, crystallizers, dryers, stock preparation, wood digesting, bleaching, evaporation, chemical preparation, primary reforming, methanol distillation, byproduct drying (corn dry mills pretreatment and conditioning, lignocellulosic processes), and furnaces such as cracking furnaces.

For purposes of this disclosure, a hydrogen boiler is any boiler that has been specifically modified to use hydrogen as combustion fuel. For purposes of this disclosure, a hydrox boiler is any boiler that has been specifically modified to use a mixture of hydrogen and oxygen (such as hydrox) as the reactants in a boiler. In some embodiments, this definition includes a modified condensing boiler. In these or other embodiments, the mixture of hydrogen and oxygen is generated locally to the boiler by electrolysis and not separated before delivery to the boiler. In other embodiments, the mixture is prepared before entry into the boiler. In these or other embodiments, the mixture is prepared simultaneously with entry into the boiler or prepared shortly after entry into the boiler.

For purposes of this disclosure, a hydrogen furnace is any furnace or industrial furnace that has been specifically modified to use hydrogen as combustion fuel. Likewise, for purposes of this disclosure, a hydrox furnace is any furnace or industrial furnace that has been specifically modified to use hydrogen and oxygen (such as hydrox) as the reactants.

For purposes of this disclosure, a hydrogen turbine is any turbine or industrial turbine that has been specifically modified to use hydrogen as combustion fuel. Likewise, for purposes of this disclosure, a hydrox turbine is any turbine or industrial turbine that has been specifically modified to use hydrogen and oxygen (such as hydrox) as the reactants.

For purposes of this disclosure, a hydrogen engine is an internal combustion engine that has been specifically modified to use hydrogen as a combustion fuel. Likewise, for purposes of this disclosure, a hydrox engine is any internal combustion engine that has been specifically modified to use hydrogen and oxygen (such as hydrox) as the reactants.

A “module” is the photovoltaic media, PV wire connections to the media, and any support, such as frames, that the module manufacturer adds to the media. Modules have a capacity greater than 100, 200, 300, 400, 500, 600, or 800 watts and less than 2000, 1500, 1000, or 900 watts and a size greater than 1, 2, 3, 4, 5, 6, 7, 8, and 10 m3.

“Array” is a grouping of multiple modules, some of which are next to three separate modules. In some implementations, an array has greater than 5, 10, 15, 20, 30, 40, 50, 60, 70, 80, 90, or 100 columns of modules. In some implementations, an array has greater than 5, 10, 15, 20, 30, 40, 50, 60, 70, 80, 90, or 100 rows of modules. In some implementations, an array has more than 50, 100, 200, 400, 600, or 800 modules. Sometimes, rows or columns have two or more modules. Module-to-module spacing for site-oriented systems can be much, much closer. In some implementations, module-to-module spacing in an Earth-mounted system ranges from 0.1 300 mm, 10-200 mm, 1-50 mm, or 1-25 mm.

“Contiguous” or “adjacent” modules, rows, or columns means modules, rows, or columns having a spacing of less than 30, 20, 10, or 5 cm “Conterminous” means that each member of a group or grouping is next to at least one other member.

“No favored orientation” means that the array is oriented with respect to a geographic feature on the site, e.g., river, stream bed, canyon, hill, etc. In some embodiments, the array is not oriented with respect to the sun's direction. “Geographic feature” includes legal property lines but does not include latitude, longitude, or the orientation of impinging sunlight. Systems with no favored orientation are sometimes called earth or topography oriented. Azimuth independent means independent of the orientation of the sun with respect to the module's latitude.

In some implementations, “Earth-mounted” refers to a group of greater than 50, 100, 200, 400, 600, 800, 1000, or 1500 modules in which at least 80 percent of the modules have at least one contact point, as defined below, that rests on the ground or rests on a contact surface of one or more structures, provided that the portion or portions of the structure or structures encompassed by the volume of space beneath and perpendicular to the contact surface is solid or constrains air movement. In some implementations, “Earth-mounted” means any flat mounting substantially parallel to the earth or ground that places the plane of the array within a short distance above the ground. This disclosure sometimes uses “ground-mounted” as a synonym for “Earth-mounted”. In some versions, “flat” means horizontally flat and substantially parallel to the earth. In some implementations, a “ground module” is an Earth-mounted module.

In some versions, “contact points” are regions of a module that touch the ground or touch a contact surface. In some versions, “contact points” are regions of a module that touch the ground without intervening regular structure or are regions of a module that touch the ground without intervening manufactured structure.

“Contact surfaces” are portions of a structure that touch a contact point. In some implementations, the volume perpendicular to the contact surface between the contact surface and the ground does not have free air. In some implementations, an object that does not have “free air” is an object that does not contain constrained air. In some versions, a contact surface defines a starting point of a path that is continuous and ends at a point of the structure touching the ground and directly beneath the contact surface.

In some implementations, the volume perpendicular to the contact surface between the contact surface and the ground constrains air movement. In some versions, “constrains air movement” means constrains lateral air movement. In some implementations, an object that “constrains air movement” bounds a volume of air on at least two lateral sides. In some implementations, “constrained air” is air constrained on at least two lateral sides in addition to the top and bottom.

For purposes of this disclosure and depending upon the implementation, “utility-scale” means having one or more of the following characteristics: a total DC output of greater than 200, 300, 400, 500, 600, 700, 800, 900, 1000, 1100, 1200, 1300, 1400, 1500, 1600, 1700, or 1800 V; or a total DC power output of greater than 100, 200, 500, 700, 1000, 2000 kW.

In some implementations, “ground level” is the level of the ground immediately before module installation.

“Ground” or “native topography” is the surface of the site and includes material naturally present at the site and material added to the site by human activity at any time before the first module is placed. In some implementations, “Ground” or “native topography” is the surface of the site and includes material naturally present at the site and irregularly shaped material added to the site by human activity at any time before placing the first module. In some implementations, “Ground” or “native topography” is the surface of the site and includes material naturally present at the site and material added to the site by human activity at any time before placing the first module, provided that the largest dimension of 80% of the material is less than 20 cm.

“Structure” is any material added to the site or brought onto the site that occupies any of the space between a module and the ground and does not include manufacturer support. “Structure” is support for the module not installed by the panel manufacturer during production.

Perpendicular and parallel are defined with respect to the ground's local tangent plane.

“Plane of the array” is the average of the planes for each individual module in the array.

“Robotic cleaning device” is an air-pressure-based, water-pressure-based, vacuum-based, brush-based, or wiper-based device for cleaning modules.

“Autonomous” means performed without manual intervention or undertaken or carried out without any outside control. For example, an “autonomous robotic device” is a robotic cleaning device that operates to clean modules without real-time human control. An “autonomous robotic device” is sometimes used synonymously with a “fully autonomous cleaning robot”. An AI autonomous robotic device is an autonomous robotic device that contains hardware and software that observes its own cleaning performance and adjusts its performance algorithms based on those observations.

In some implementations, “operates to clean modules” includes initiating a cleaning cycle.

A “cleaning cycle” is a complete cleaning of a section of modules from start to finish. In some implementations, a cleaning cycle includes the robotic device leaving its resting pad or structure, traveling to a section of modules, cleaning each module of the section, and traveling to another section or returning to the resting pad or structure.

“Cleaning period” is 6, 12, 24, 36, 48, 60, 72, 84, 96, 108, 120, 132, or 144 hours.

“Module-to-module z-axis variability” or “module-to-module elevation difference”—is a measure of the largest elevation difference between the highest point at a module edge and the lowest point of an adjacent edge of an adjacent module. The “z-axis” extends from the module face and points substantially vertically.

In some implementations, when used to describe an array, “smooth”, “smoothed”, “flat”, or “flattened” means smooth or flat enough or made smooth or flat enough such that the height difference or the module-to-module z-axis variability between adjacent modules is small enough that a fully autonomous cleaning robot can move from one module onto another. For example, the maximum module-to-module z-axis variability in some implementations is less than 4, 3, 4, 1, or 0.5 inches. Likewise, in some implementations, when used to describe the ground, “smooth”, “smoothed”, “flat”, or “flattened” means smooth or flat enough or made smooth or flat enough such that the height difference or the module-to-module z-axis variability between adjacent modules in an array installed on the ground is small enough that a fully autonomous cleaning robot can move from one module onto another.

“Low module elevation” is defined as an elevation of a module that is low enough to prevent upward forces caused by air movement across the module from lifting a module from the array, whether the array comprises mechanical components to resist module lifting or not. In some implementations, a low module elevation is defined as an elevation of a group of modules that is low enough that air-caused upward forces on the group are too small to lift the group. For example, in some implementations, low module elevation is an elevation of less than 100 cm, 0 to 90 cm, 0 to 80 cm, 0 to 70 cm, 0 to 60 cm, 0 to 50 cm, 0 to 40 cm, 0 to 30 cm, 0 to 20 centimeters, or 0 to 10 cm measured from the ground to a lower edge of the module or, in edge-less module systems, from the ground to the module surface.

“Intermediate distance” is defined as from 0-1 m, 0-70 cm, 0-60 cm, or 0-50 cm. “Short distance” is defined as 0-49.9 cm, 0-30 cm, 0-20 cm, or 0-10 cm.

“Mechanical stow functionality” is functionality that changes the direction that a tracker-based system points the modules to minimize the effect of winds on the system. This minimizes the danger of high winds damaging the tracker or the installed modules.

“Extreme dampening functionality” is functionality that dampens mechanical oscillations in a tracker-based system caused by high winds to minimize the danger that those winds will damage the tracker or the installed modules.

“Connectors” are structures that connect modules. In various implementations, connectors can be mechanical connectors, electrical connectors or electrical interconnects, or both. “Electrical interconnects” are DC electrical connections between modules.

“Flexible connections” or “flexibly connected” are or describe connections made with rigid or non-rigid connectors that allow the angle between a plane of a module and of an adjacent module to vary without breaking the connection.

“Joints” are any permanent or semi-permanent connection between the joined components.

A “high DC:AC” voltage ratio is greater than 1.0-2, 1.1-1.9, 1.2-1.8, and 1.3-1.7.

Having thus described some embodiments of the invention, other variations and embodiments that do not depart from the spirit of the invention will become apparent to those skilled in the art. The scope of the present invention is thus not limited to any particular embodiment but is instead in the appended claims and the legal equivalents thereof. Unless stated in the written description or claims, the steps of any method recited in the claims may be performed in any order capable of yielding the desired result. No language in the specification should be construed as indicating that any non-claimed limitation is included in a claim. The terms “a” and “an” used in the context of describing the invention (especially in these claims) are to be construed to cover both the singular and the plural unless otherwise indicated or contradicted by context.

1. A method comprising generating process heat from hydrox.

2. The method of claim 1, wherein the hydrox comprises at least 10%, 50%, 60%, 70%, 90%, or 99% by volume or by weight of a material having a stoichiometric ratio of hydrogen gas and oxygen gas.

3. The method of claim 2 further comprising a step of providing an electric hydrox generator (EOG).

4. The method of claim 3, wherein the EOG comprises an electrolyzer.

5. The method of claim 4 further comprising a step of operating the EOG to produce oxyhydrogen.

6. The method of claim 5, wherein the electrolyzer produces hydrox.

7. The method of claim 6, wherein the electrolyzer has two or more cells.

8. The method of claim 7, wherein the electrolyzer or some of the two or more cells have a variable resistance function.

9. The method of claim 8, wherein the variable resistance function is measured or controlled electrically, mechanically, or electro-mechanically.

10. The method of claim 9, wherein the EOG operates using photovoltaic electricity.

11. The method of claim 10, wherein photovoltaic electricity comes from a group of modules arranged flatly on the ground.

12. The method of claim 11, wherein the group has 100 or more photovoltaic modules.

13. The method of claim 12, wherein the EOG produces electricity with the modules and the electricity flows through a power path to the electrolyzer.

14. The method of claim 13, wherein the power path does not contain a device that functions to adjust the voltage of the electricity in the power path.

15. The method of claim 13, wherein the generating step comprises combusting the hydrox to form a combustion exhaust having less than 1000 NOx ppb.

16. The method of claim 13 further comprising a step of providing an hydrox boiler.

17. The method of claim 16, wherein providing process heat comprises providing more than 2000 lbs of equivalent steam heat per hour.

18. The method of claim 17 further comprising a step of providing an hydrox furnace.

19. The method of claim 18, wherein providing process heat comprises providing more than 2000 lbs of equivalent steam heat per hour.

20. The method of claim 19, wherein the generating step comprises combusting the hydrox to form a combustion exhaust having less than 1000, 500, 250, 100, or 50 ppb NOx.
